(19) United States
(12) Patent Application Publication
(10) Pub. No.: US 2010/0301045 A1
(43) Pub. Date: Dec. 2, 2010

(54) METHOD FOR FORMING A LID AND SUCH SEAMABLE LID ITSELF

(75) Inventor: Guy Docrot, Saint-Cloud (FR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Impress Group B.V.

(21) Appl. No.: 12/739,051

(22) PCT Filed: Oct. 27, 2008
(86) PCT No.: PCT/EP2008/064553

§ 371 Date: Aug. 16, 2010

(30) Foreign Application Priority Data
Oct. 25, 2007 (EP) 07119332.0

(51) Int. Cl. B65D 51/18; B23P 19/04

(52) U.S. Cl. 220/254.1; 29/592

(57) ABSTRACT

A method for preparing and forming a gripable and flat lying retortable lid having a lid ring extending radially outside in a curl shape adapted to be seamed to a body flange of a container body, and extending radially inside in a substantially flat flange, sealed with an edge ring of a central foil, covering an inner opening of the lid ring, radially inside of the inner end of the flat flange is described. The central foil having a tab extending from a radially outer end radially inside, and lying substantially parallel and close to an upper surface of the central foil. The tab has two radially extending portions, an outer one and an inner one. The inner portion rising axially upward, during a press or squeeze operation in an intermediate portion between the inner and outer portions, to force the inner portion away from the foil surface and keep the outer portion substantially parallel to the foil.

### CROSS-REFERENCE TO RELATED APPLICATIONS

This application is the U.S. National Stage filing of International Application No. PCT/EP2008/064553, filed Oct. 27, 2008, which claims priority to European Patent Application No. 07119332.0, filed Oct. 25, 2007, the disclosures of which are hereby incorporated by reference.

### FIELD OF THE INVENTION

Embodiments of the invention relate to a method for preparing and forming a lid. The lid has a lid ring (Deckelring, annular component) and a lid foil (membrane), which work together and are coupled together by a sealing portion which seals in ring-like fashion the membrane to a panel of the preferably metallic ring.

The metallic ring is outside formed to have a seaming edge (seamable outer portion) which is provided and shaped to be seamed by a multiple seam to a body flange of a body wall to cover the body with the ring and the foil, in other words to cover the body with the lid.

### BACKGROUND

Lid rings of metallic nature and lid foils of metallic, plastic or a combinatorial nature are known in several sorts and shapes. The flat ring flange onto which the foil is sealed (where the lid foil is sealed) has several different orientations. It can be horizontally oriented, it can be tilted upwards, and it can also be tilted downwards. It can even change its shape during sterilization of a closed container, where inner pressure supplies force in axial direction to act on the foil, transferred to the sealing portion and to the panel (ring flange). Different orientations can therefore be present, as well as different orientations can be selected for the foil covering the inner opening, which it covers before, during and/or after a sterilization process, examples of which are shown by WO-A 2007/088212 (Impress), WO-A 2005/005277 (Crown) and WO-A 2007/45385 (Alcan).

All these variants operate with foils that have different shapes during a sterilization process. The sterilization process provides high pressure and high temperature to make the food inside the container stable for longer storage and transport, and during this sterilization of up to 130° C., a pressure has to be resisted by the lid.

After such sterilization process, the lid has a task to provide long-time self-life, until a user wishes to open this lid. At this very time instant, the opening forces have to be very low, as contrary to those forces the lid and the foil have to withstand during sterilization processes. Not all processes in sterilizing do have counter-pressure, as many processes operate with continuous retort systems. In this field, it is a task of the invention as technical problem to provide a lid that has superior properties.

The problem to solve is to provide a tab that should lay closely with the membrane (foil). During all the process(es) on/in the filler's production line, the tab should not rise up, but stay as close as possible with and along the foil, considering the length of the tab that is near the panel of the lid ring, where the foil is sealed. The tab should still provide a grip portion that can be gripped by an end user when wishing to open the lid, which may occur far after the sterilization process. The grip portion can not be lying parallel and very close to the foil; it must rise up or bend away from the foil, as having this shape after sterilization and during transport and storage as well as shelf life. This appears to be a contradictory problem, even more emphasized when thin foils are more commonly used in the future, and the tab that is provided with a strip made from the same material as the foil, has no own rigidity to actively keep the position that it has been placed to.

### SUMMARY OF THE PREFERRED EMBODIMENTS

This problem may be solved by a method according to exemplary embodiments. The lid ring extends radially outward with a curl. This provides a shape to seam the lid ring to a body flange. Radially inward, the lid ring has a panel that is a flange, adapted to receive a foil sealed to it. The foil closes the inner opening of the lid ring, which in most cases is circular, but can also have other shapes like oblong, rectangular and square. An upper tool acts positively on an intermediate portion of the tab (and the underlying foil portion) to squeeze or press them together and urge the inner tab portion upwards at an angle, away from the parallel position with respect to the foil.

The problem may be solved by a lid according to exemplary embodiments. The lid ring extends radially outward with a curl. This provides a shape to seam the lid ring to a body flange. Radially inward, the lid ring has a panel that is a flange, adapted to receive a foil sealed to it. The foil closes the inner opening of the lid ring, which in most cases is circular, but can also have other shapes like oblong, rectangular and square. A squeezed or pressed portion of the tab has the inner portion of the tab urged upwards at an angle, with only the inner portion urged upwards.

The central foil is provided with a tab that is preferably an extension of its material and is preferably folded over to be as close as possible next to the foil extension. The tab provided thereby is strip-like and can have a narrowing end extending radially inward. The outer end is next to the radially outer end of the sealing portion of the flat panel of the metal ring. This outer end can be a fold of about 360°, it can also be an attaching place, to fix a separate tab in a suitable way by sealing, gluing or riveting to the outer end of the central foil.

The radial inner end of the tab lies over the inner opening, above the foil, closing this opening. Foil and tab are in a substantially parallel relation. The inner portion then rises axially upward (upon a pressing or squeezing action), but is limited in length extension. The remainder of the tab lays (or is maintained) close to the sealing foil, whether the lid ring has a panel that is extending slanted upwards, purely horizontal, or slanted downwards. The sealing foil will follow this primary direction of the panel of the lid ring, as will follow the tab the orientation of the foil.

The shape of the central foil may have many geometries in two aspects. Its basic shape depends on the shape of the lid ring as explained below. Its vertical shape depends on the orientation of the flat ring panel, and whether this is directed horizontally, slanted upwards or slanted downwards. The central portion of the panel therefore is either flat, domed downwards or domed upwards. It can change its shape due to pressure exerted from the inside of the filled container during sterilization, changing the surface in its shape and taking with this change of shape the tab that is oriented parallel or along the surface of the foil.

According to this embodiment, the shape of the lid ring is round, however, it can have oblong, square and elongated shapes as well. An inner end of the flat ring panel of the lid ring can have many shapes, an open curl, a closed curl, a flattened end of dual material layer (folded in or folded out), and a non-treated cut end. Preferred are closed curls or free cut ends that are covered by the overlying central foil.

More than half of the length extension of the tab, up to more than two thirds, may lay next to the foil; just the inner end portion of the tab will rise upwards. This will allow a finger to grip below the upwards directed end and grip this inward directed end of the tab to tear up the tab and open the foil by opening the sealing barrier and tearing up the foil from its attachment on the panel.

The shape of the tab is prepared by a press or squeeze operation, in which an upper tool and a lower tool work together. The upper tool provides a press or a squeeze force onto the tab in an area that is intermediate between the radially outer area and the shorter radially inner area of the tab, to make the inner area of the tab rising upwards by pressure or compression and reactive forces thereof. The press or squeeze operation is provided prior to closing, it may be provided during manufacture of the lid. The lid can then be stacked and sold and transported separately, or the lid can be attached to a body flange, leaving a three-part can open towards the bottom end, for filling. Then the lids together with the container bodies may be supplied to a customer.

The sterilization process occurs at the filler's plant, and the lid manufacturing might either be concluded when the lid is finished, or might be concluded when the lid and an additional body portion are seamed together.

Prior to the sterilization process, the press or squeeze operation is carried out between the inwardly extending tab, preferably as a folded back tab, and the seamed foil. This is in an area that is radially inward from the inner end of the flat flange and radially outward of the inner end of the tab. This is the intermediate portion between the two end portions of the tab, allowing the larger extent of the tab to stay close to the foil. A small portion at the radially inward end is rising upward and away from the foil.

The squeeze can be done in a line or strip portion, preferably along the whole width of the tab. It can also be dot-shaped. Preferably, a strip will provide enough compression force to squeeze or press the tab in the intermediate portion together with the foil, and—as a reaction or result—force the inner end of the tab axially upwards to open a gap, to later allow a human finger to reach or grip below this upward forced end.

The upward end is low enough to not prohibit or harm any sterilization processes, where the lid might change its shape and axial position. This squeezing or pressing also ensures that very thin foils and tabs, preferably those that have very little aluminum in it, keep and stay in this position, where the two tools have provided them to stay.

Preferably, the angle is between 10° to 45° as a sort of mean value of the shape of an upwards extending inner end of the tab, with respect to a horizontal plane. To reach the press or squeeze operation and the forces, one of the tools approaches the other, thus tools are moved relative to each other. As the lid is not yet fastened by a seam to a body, it can be readily handled and can be easily placed between the two tools providing the squeeze or press operation. To allow movement or extension of the inner end of the tab upwards, the upper tool has a cavity, into which the enforced bending of the inner end of the tab will occur. This is a free shaping of the inner end of the tab, forced or enforced by pressure and compression as well as deformation in a portion further radially outward than the radially inward end of the tab.

It night preferably gain a cup shape, when the place of pressure introduction and squeezing operation is more or less dot-shaped and not line-shaped. The cup is having lateral ends that shape further up than the inner central tongue portion of the tab.

The tool operates as explained and is shaped to have a flat press surface, providing the press or squeeze force to deflect or make the inner end of the tab rising upwards. This flat press surface acts in the intermediate portion of the tab. There is a flat holding portion radially outward, which can either be passive or can further provide forces onto the tab portion that is radially outward of the intermediate portion to force it close to the foil. Radially inward of the intermediate portion that is acted on by the flat press surface, there is the cavity that receives the upward bent (or “upward bending”) inner end of the graspable tab. This upward end is designed to allow a human finger to grip below it and tear the tab upward and away to release the foil from the sealing portion, in other words to open the container and gain access to the content.

The preferred shape of flat press surface of the upper tool is a strip-shape. A strip also is line-shaped but will have a larger radial extension. When a small width of the line is presented, the strip is reduced to a thin line, when a thin line extends in radial direction, it will become a more or less wide line or a strip. This strip is still narrow (or limited in its extension), but it can also have a dot-shape which does not reach both lateral ends of the tab. The strip/line can have several forms or shapes in vertical section, a soft protrusion shape, further extending to a U-shape, to effect a deeper impact on the intermediate portion, but actually axially deforms both, the tab intermediate portion and the corresponding underlying portion of the foil. They both will gain a U-shape. Further vertical section shapes of this protrusion can have V-form that also affects the intermediate portion of the tab and the corresponding underlying portion of the foil. This is seen in a vertical section, but also in horizontal or in lateral direction there can be several modifications. The line can be straight or the line can be slightly curved or bent in horizontal direction, to enhance the upward folding or upward rising action of the inner racial end portion of the tab. The line itself is not necessarily a continuous line, but can also be a discontinuous, dotted or broken line, in both straight and/or curved/bent manner.

All these tools have a cavity in their radial inner end, which allows the radial inner end of the tab to rise axially upward during the press or squeeze operation of the corresponding upper tool.

The foil preferably has a size that is adapted to the ring and slightly larger than the inner opening. The thickness of the foil is less than about 100 μm, and can preferably be as thin as 50 μm to 60 μm, when thinner aluminum layer portion or no aluminum portions as layers are used. The foil then consists of at least one or two plastic layers, with no metallic intermediate layer. Presently available foils are still thicker and have at least two or three layers.

The inner layer, according to exemplary embodiments, have a thickness between 60 μm to 80 μm, preferably an aluminum layer covered on both sides by plastic layers that are thinner than the aluminum layer, but the layers can provide protection and allow sealing.

The foil can extend into the tab with the same material and layer characteristics in the tab as is throughout the central foil. When the tab is a separate device that is attached to the outer end of the central foil, it can have a material of different properties, it can be thicker, thinner and of other layer structure or of other material components along its structure or layers. This tab will then have to be fastened to the outer end, which can be done by gluing, by sealing and by providing the riveted or corrugated connection portion.

Exemplary embodiments as depict herein in the Figures support the understanding of the embodiments as claimed.

### BRIEF DESCRIPTION OF THE DRAWINGS

FIG. 1 is a perspective view of a lid having a foil 3 to close the center opening and a tab 10 as well as an outer portion that is adapted to be seamed to a non shown body.

FIG. 2a, FIG. 2b show vertical sections A-A of FIG. 1, only in the radial outer portion.

FIG. 3 shows the section of FIG. 2, when operated or treated in between an upper tool 30 and lower tool 40.

FIG. 4 shows the upper tool 30 (enlarged) that provides the press or squeeze force into the intermediate portion 10e of the tab to lift up the inner end 10b of the tab 10.

FIG. 5 is an enlarged depiction of the outer end portion of the lid 1, having the lid ring 2, the tab 10 and an outer end ring 3b of the foil 3, covering the inner opening 8.

FIG. 5a is a section a portion of a multi-layer foil used for any of the embodiments of the prior figures.

FIG. 5b is another embodiment of a lid multi-layer foil used for any of the embodiments explained above.

FIG. 6a, FIG. 6b show different shapes provided by the upper tool 30 and its protrusion 32 (enlarged). The protrusion provides the press or squeeze force into the intermediate portion 10c of the tab to lift up the inner end 10b of the tab 10, and effects the shape of deformation, shown in several embodiments here.

FIG. 7a to FIG. 7e show different line shapes of the press and squeeze force and its effect in portion 10c.

### DETAILED DESCRIPTION OF THE PREFERRED EMBODIMENTS

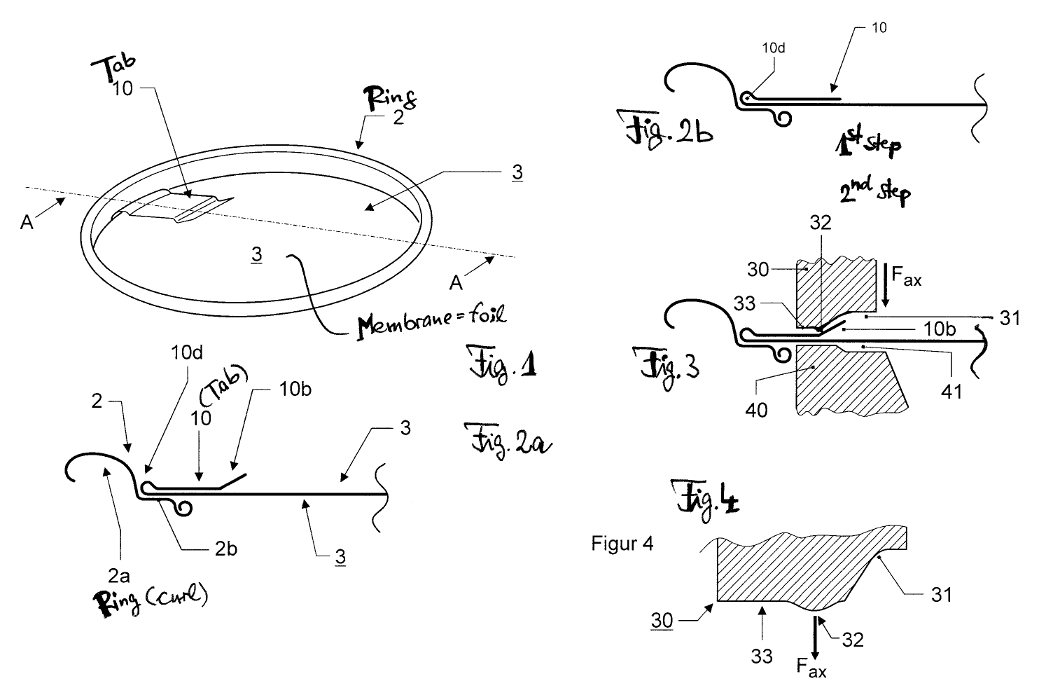

FIG. 1 as perspective view shows some of the elements used in exemplary embodiments. The tab 10 is provided as an elongated portion, close to the covering foil 3. The lid ring 2, preferably made from metal, but could as well be stiff plastic, has an outer curl 2a that is shown in section in FIG. 2a. This curl is suitable to be seamed to a body flange (not shown here, but common in the technical field).

The tab 10 reaches out to the outer, preferably circumferential, edge of the foil, where it has a fold portion 10d, folding it back inwards and keeping it close to the profile of the membrane 3 as covering foil. An inner end portion 10b is tilted, as more shown in subsequent figures, to rise up from the surface extension of the foil 3, allowing a finger grip to pick it up and tear along the tab 10. This shear force will open the sealing ring layer 9 that is provided as shown in FIG. 5.

Ring zone 9 as sealing provides a liquid tight seal of the foil 3 in its outer end ring 3b with respect to the lid ring 2 and its flange or flat ring panel 2b.

The shape of the lid ring is round in this embodiment, however, it can have an oblong, a square and an elongated shape, for example. An inner end 2c of the flat ring panel of the lid ring can have many shapes, such as, an open curl, a closed curl, a flattened end of dual material layer (folded in or folded out), and a non-treated cut end. Exemplary embodiments may include closed curls or free cut ends that are covered by the overlying central foil.

The shape of the central foil may have many geometries in two aspects. Its basic shape may depend on the shape of the lid ring 2 as described above. Its vertical shape may depend on the orientation of the flat ring panel 2b, and whether it is directed horizontally, slanted upwards or slanted downwards. The central portion 3c of the panel 3 may therefore be either flat, domed downwards or domed upwards. It can change its shape due to pressure exerted from the inside of the filled container during sterilization, changing the surface 3″ in its shape and taking with this change of shape the tab 10 that is oriented parallel or along the surface 3″ of the foil.

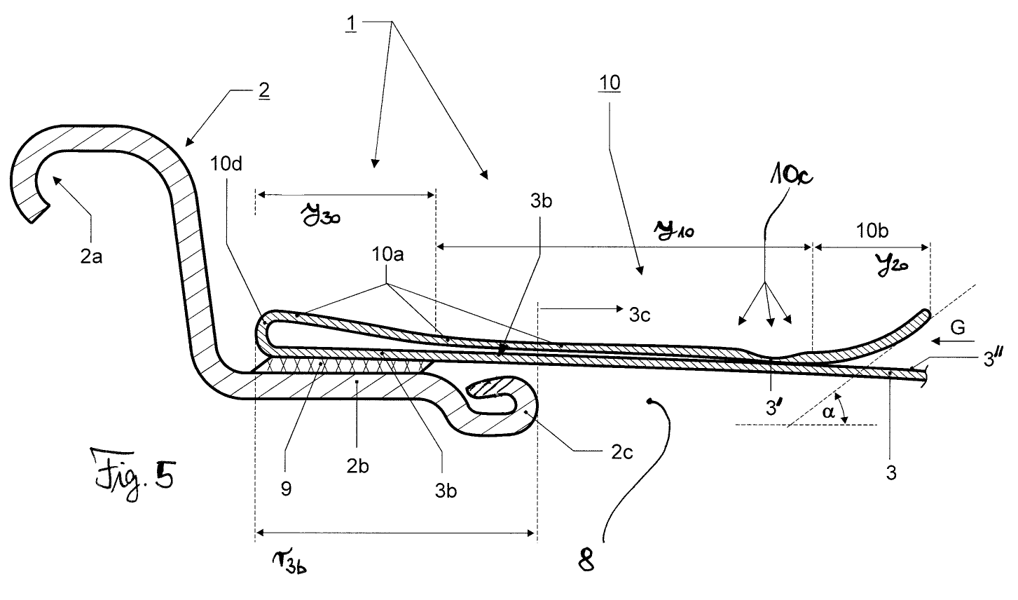

The tab 10 will now be described. It has a flat (or fully parallel) initial position as shown in FIG. 2a, and it has a position after operating the upper and lower tools 30, 40 as shown in FIGS. 3, 4.

The extension of the foil 3 with its surface 3″ is to cover the opening 8 of the lid ring 2. The foil 3 has a central portion 3c and an outer portion that overlies the flat ring panel 2b and its inner curl 2c. Only a part of this portion is sealed with a sealing zone 9 to the flat ring panel 2b. This is length portion y₃₀. The larger length portion y₁₀ extends radially inwards therefrom, and until that place of the tab 10, where it starts having an inner end portion angled upwards in an angle of between 10° to 45°, in FIG. 5 shown slanted to about 45° as the angle α. This angled upwards portion is rising axially upwards during a pressing or squeezing operation as described with respect to FIGS. 3 and 4, has a length extension y₂₀, which is less than one third of the sum of all length definitions y₃₀ to y₁₀.

The foil 30 has an inner portion 3c and an outer portion 3b. In this embodiment, the inner portion 3c is circular and the outer portion 3b is ring-shaped. The material of the tab 10 is the same as that one of the central foil 3, as explained in more detail in FIGS. 5a and 5b, not explicitly shown in FIG. 5. The tab has a fold portion 10d, emerging from the outer portion 3b of the foil, and folding back inwards to extend with the angled upwards inner end 10b, substantially away from the inner end 2c of the flat ring panel 2b. The outer radial portion 10a of the tab extends from the fold portion 10d radially inwards towards the intermediate portion 10c, which is at the radial inner end of the extension y₁₀.

As can be seen in FIG. 5, initially the surface 3″ of the foil 3 and the length extension of the tab 10 are substantially parallel. Having another slope of the foil 3, it may still be parallel by having the tab extension lying close to the surface of the foil. To enhance this close relationship, an upper tool 30 and a lower tool 40 are provided to press or squeeze by an axial force Fₐₓ in the intermediate portion 10c to provide a forced displacement of material and an intimate physical contact 3′ between the tab 10 in at least a part of the intermediate portion 10c and the surface 3″ of the foil 3. Displacing material and putting pressure as pressing or squeezing into this position, may force a reaction of the inner end 10b of the tab that was previously lying substantially parallel to the foil and will now rise up in the angled position as shown in FIG. 5.

A finger can grip in position G below the inner end portion 10b. The length of this portion is y₂₀ and allows a normal finger to reach both surfaces of the inner end 10b, to allow gripping this and tearing along the tab 10, opening the sealing zone 9 and the lid by a customer. This opening operation is sometime after the end of the sterilization, and until this time, the tab stays closely related, and having the inner end 10a rising upwards for use by the customer. During sterilization, the same applies and the uprising end 10b is not detrimental to the process of sterilization. As explained, during this sterilization the lid foil 3 might change its shape and might be displaced cup-shaped upwards, and a very long freestanding end of a tab 10 would obstruct the sterilization process, especially in continuous retort systems.

To provide the angled, axially upward displacement of the inner portion 10b of the tab, the lid as shown in FIG. 5 is placed between the upper tool 30 and the lower tool 40. The upper tool has a protrusion 32 which extends downwards and may be line-shaped or dot-shaped. Radially outward of this protrusion, for providing the press or squeezing force in operation, is a flat holding portion, and radially inwards is a cavity 31, which receives the folded upwards inner end portion 10b of the tab, when the protrusion 32 acts on a part of the intermediate portion 10e, displaces material and lifts up the inner end portion 10b by displacement of material and pressing or squeezing a certain amount of foil material of the tab, providing the intimate contact 3′ with the upper surface 3″ of the foil 3 in the place of the protrusion 32.

As can be seen in FIG. 4, the protrusion 32 which acts to provide the pressing force Fₐₓ can have a shallow protrusion which is line-shaped laterally, across the tab extension, and has radially outward and radially inward the two portions 33, 31, as described above.

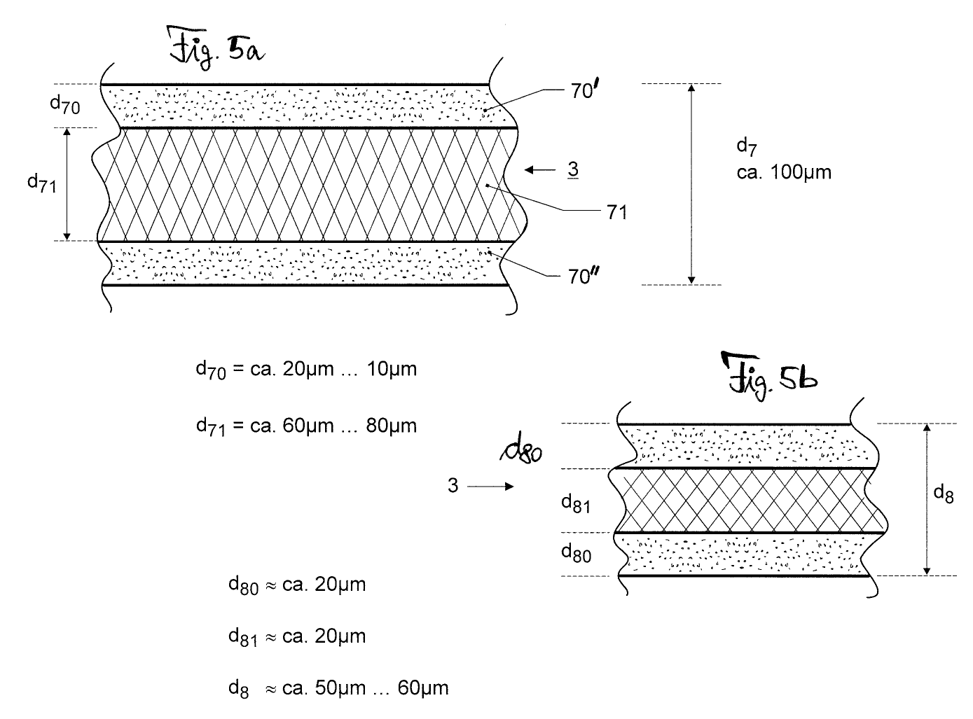

The upper tool of FIG. 4 is again shown in FIGS. 6a, 6b, as it acts on the intermediate portion 10c of the tab 10. The tool of FIG. 6a has a V-shaped protrusion 32′. The tool of FIG. 6b has a U-shaped protrusion 32″. Both tools 30 have the radially inward and upward extending cavity as the inner tool end, to allow the axially upward movement of the tab inner end 10b. The shape of the tool is different from the relatively smooth protrusion shape 32 of FIG. 4. The shape of V and U are more exposed, to also act deforming on the foil 3 below the intermediate portion 10c of the tab. The intermediate portion 10c′ will receive a V-shaped groove, as the corresponding underlying portion of foil 3 will receive the same shape. The U-deformed shape of FIG. 6b will also affect both, the tab 10 and the underlying portion of the foil 3, where the arrow 10c″ points to.

The lower tool 40 has a corresponding inverse shape, not separately shown in FIGS. 6a, 6b.

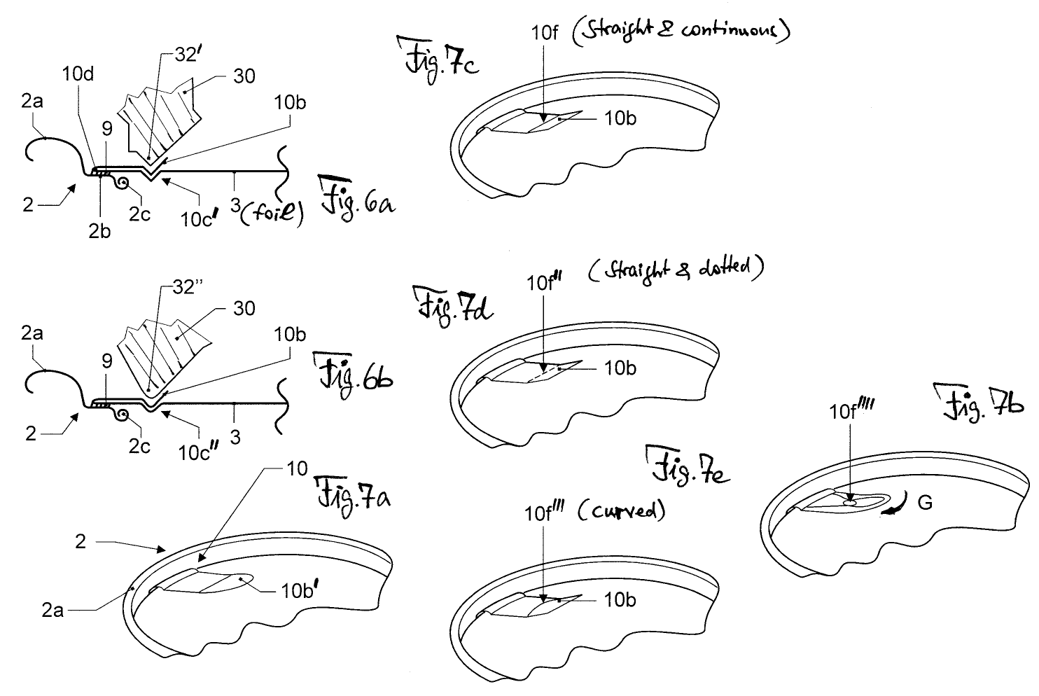

All the above described tools may have, in a lateral direction, shapes that are exemplified in FIGS. 7c, 7d and 7e. The tab inner end portion 10b is slanted upwards, and this is effected by the protrusion 32, 32′ or 32″ making a press and squeeze line, either as a straight line 10f, as dotted or broken line 10r or as laterally curved or bent line 101″. The tool can have broader or smaller width of this line having the different shapes 10f, and the line will then be a strip portion which is wider than the line as such, but still be narrow in radial extension.

Two other shapes are exemplified in FIGS. 7a and 7b. FIG. 7b shows a dot shape of the press and squeeze operation, effecting a shape of the tab inner end portion 10b to be schi-shaped or with other words, having a cup shape, where the lateral portions are bent upwards, and the inner end is also bent upwards and slimming in width. The dot can be smaller or wider in its radial extension and is effected by an upper tool, similar to that shown in FIGS. 3, 6a and 6b.

The shape of a inward slimming tab with a smaller inner end portion 10b′ is shown in FIG. 7a, also rising axially upwards during press or squeeze operation of the upper tool 30.

Not separately shown is the outer end 10d of the tab, which is shown in all embodiments to be folded over. This fold can be replaced by an attaching portion, when the tab 10 is a separate device, but is initially fixed to the outer end portion of the central foil 3, and has a flat extension as shown in FIG. 2b in the first step. The fold 10b is then not present, but will be replaced by an attaching place, either glued, sealed, provided by a rivet or any other suitable corrugation which allows to transport force when pulling the tab 10 for opening the sealing strip 9 below the ring portion 3b of the foil 3.

The lid itself is held in a fixed position between upper and lower tools 30, 40 and either the upper or the lower, or both tools are axially displaced forward towards the foil 3, to minimize the gap and to effect a pressing force. This is for all shapes of protrusions 32 and all explained tools 30, 40.

The holding portion 33 of the upper tool 30 can support the orientation of the outer portion 10a, to be kept in parallel and close to the foil, prior to the start of the inner curl 2c.

Both tools are radially inside of this inner curl end 2c, and do not effect forces or pressing action onto surfaces of the tab 10, radially outward the central portion 3c of the foil 3.

When the protrusion 32 is dot-shaped or has some circular extension, the shape of the angled-upward inner end portion 10b will be substantially cup-shaped, having lateral end edges, which bulge upwards, as material is displaced in more directions. When only line-shaped protrusions are present, the material displacement may be purely radial. With dot- or enlarged dot shaped protrusions, the material may be displaced circularly 10f″, from the respective contact point or contact zone of a circular protrusion with tab material in the intermediate portion 10c.

Opening both tools 30, 40 allows withdrawal of the prepared lid, which may then be formed and shaped, and prepared for use in retort systems. The lid is also provided to be used by (end) customers after having been subject to sterilization processes, and this end user (customer) may still use the upwardly angled inner end portion 10b. Compared to the radial extension of the upper tool 30, the protrusion 32 can be called a narrow strip or small dot-shaped extension. The achieved upward angle is between 10° to 45°, the specific embodiment showing more than 40°, and a very short inner end portion 10b, which is between one fifth and one sixth of the overall length y₃₀+y₁₀+y₂₀ of the tab 10. The angle is most preferred between 20° to 30°.

The upper tool 30, a hammer or coining tool, does not reach radially outward over the ring-shaped portion r_{3b}. In this area, the outer portion thereof, which extension is termed y₃₀, can have some space between the tab extension close to the fold 10b and the sealed outer ring 3b of foil 3 which is still considered to be substantially parallel and close to the upper surface of the central foil. Thus, the main extension y₃₀ plus y₁₀ of the tab length is close and substantially parallel to the foil 3, no matter whether this is horizontally shaped, bulging upwards or downwardly cup-shaped, with a depending flange ring 2b of the lid ring 2.

In a specific embodiment, preferred in design, the inner end portion 10b is narrowing towards its inner end, separately shown in FIG. 7a. Widening towards the radially outward direction, the protrusion 32 may cover the whole width of the tab 10, when a strip portion is used as a press or squeeze initiator.

Shapes and layers of the foil 3 are shown in FIGS. 5a, 5b.

FIG. 5a has a foil which has a thickness d₇ of substantially 100 μm. The central layer 71 is preferably of aluminum and has a thickness d₇₁, which is between 60 μm and 80 μm. The upper and lower covering layers have thicknesses of d₇₀ each, and provided as upper layer 70′ and lower layer 70″. Each of these layers has between 10 μm and 20 μm. They cover the aluminum layer 71, and the whole layer structure which has at least these three layers is used as central foil 3 and can also be used as extension over the fold portion 10d as tab 10.

The thinner this foil is, the less structural forces the tab 10 can provide to keep his closely related position with respect to the foil 3. The pressing operation with the upper tool as hammer 30 and the lower counter tool as anvil 40 will support the positioning of the tab and give this tab 10 additional rigidity as well as forming characteristics for the inner end portion 10b.

An alternative foil 3 with less thickness is shown in FIG. 5b. Three layers are provided, each one being substantially of the same thickness, a central aluminum layer d₈₁, covering layers d₈₀ on top and below, each one having about 20 μm thickness.

d₈ provides a thickness of the whole foil as multilayer foil 3, which is substantially one half of the thickness of the foil 3 of FIG. 5a. The aluminum layer as example of a metal layer, can be removed to have two plastic covering layers of thicknesses d₈₀, to even further thin the foil 3 for use as covering foil and preferably as tab provision 10.

Provided the pressing or squeezing operation as explained with respect to FIG. 5, the thinner (less) the thickness of the foil 3 is, the more important the pressing fixation may be in the intermediate zone 10c for positioning the tab. The tab therefore may avoid that during the different operation after closing the container with the lid, is folded out. The tab may not fold out after different operations in time after the closing action, and receives its final position at the end of the forming process of the lid.

1. A method for preparing and forming a lid, comprising:
forming a lid ring extending radially outside in a curl shape adapted to be seamed to a body flange of a container body, and extending radially inside in a substantially flat flange;
sealing the lid ring with an edge ring of a central foil, covering an inner opening of the lid ring, radially inside of the inner end of the flat flange;
folding a tab, that is part of the central foil and extends from a radially outer end, radially inside, the tab lying substantially parallel and close to an upper surface of the central foil;
wherein the tab comprises two radially extending portions, an outer portion and an inner portion, and
squeezing or pressing the inner portion, which is configured to rise axially upward, in an intermediate portion between the inner and outer portions, and forces the inner portion away from the foil surface and maintains the outer portion substantially parallel to the foil.

2. The method according to claim 1, the squeezing or pressing being performed in a strip portion, preferably along a whole width of the tab.

3. The method according to claim 1, wherein the inner portion of the tab extends away from the foil at an angle of 10° to 45 with respect to a horizontal plane.

4. The method according to claim 1, the inner portion being less than one third of the length of the tab.

5. The method according to claim 1, the squeezing or pressing being performed by an upper tool on a lower counter tool, that are moved towards each other.

6. The method according to claim 5, the upper tool being a hammer having a protrusion that interacts with the squeezing or pressing in the intermediate portion.

7. The method according to claim 6, the protrusion being line-shaped.

8. The method according to claim 6, the protrusion being dot-shaped, to effect a dot-shaped depression in the tab.

9. The method according to claim 5, the upper tool extending radially inside, and the inner end of the tab extending axially inside into a cavity of the upper tool, that extends radially and axially upwards.

10. The method according to claim 8, wherein inner portion of the tab extends upwards and comprises a cup shape.

11. The method according to claim 1, wherein an upwards formed tab portion is narrowed towards its inner end.

12. The method according to claim 5, wherein the upper tool is shaped in its bottom surface to have a press surface of limited extension in the area of the intermediate portion, a flat holding portion, extending radially outside therefrom, to maintain the preferably folded-over tab substantially parallel to the foil, and a cavity extending radially inside of the press surface, and axially upwards, to receive the axially upwards shaped inner end portion of the tab.

13. The method according to claim 1, wherein the foil is of a thickness less than 100 μm.

14. The method according to claim 1, wherein the foil is of a multi layer structure having at least three layers, wherein a central layer is thicker than the two outer layers and is metallic in nature.

15. A seamable lid comprising:
a lid ring extending radially outside in a curl shape adapted to be seamed to a body flange of a container body, and extending radially inside in a substantially flat flange, adapted to be sealed and sealed with an outer ring of a central foil, covering an inner opening of the lid ring radially inside of an inner end of the flat flange;
the central foil having a tab extending from a radially outer end of the central foil radially inward, preferably folded radially inside, and lying substantially parallel and close to an upper surface of the central foil along a main extension of the tab length;
three radially extending portions comprising the tab, comprising an outer portion, an inner portion, and an intermediate portion,
the inner portion rising axially upward, during a press or squeeze operation acted on the intermediate portion between the inner and outer portions, forcing the inner portion away from an upper surface of the foil at an angle between 10° to 45°, and at a length smaller than one third of a length associated with the tab, keeping the outer portion substantially parallel to the foil.

16. The lid according to claim 15, wherein the upwards formed inner portion of the tab comprises a cup shape.

17. The lid according to claim 15, wherein the upwards formed inner portion of the tab is narrowed towards its inner end.

18. The lid according to claim 15, the press or squeeze operation being performed in a strip portion, preferably along a whole width of the tab, causing the strip portion to have physical contact with the foil.

19. The lid of claim 15, wherein the tab is a separate device, that is fastened to an outer end portion of the foil.

20. The method according to claim 7, wherein the protrusion has a cross section shaped in the form of a “v” or a “u”.

21. The lid of claim 19, wherein the separate device is glued or sealed to the outer end portion of the foil.
